(19) United States
(12) Patent Application Publication
(10) Pub. No.: US 2004/0025753 A1
(43) Pub. Date: Feb. 12, 2004

(54) Cement manufacturing processes with a view to reducing NOx emissions in particular

(75) Inventors: Paul Brunner, Munchenbuchsee (CH); Stephane Marteau, Salagon (FR)

Correspondence Address: MILLEN, WHITE, ZELANO & BRANIGAN, P.C., 2200 CLARENDON BLVD., SUITE 1400, ARLINGTON, VA, 22201, US

(73) Assignees: VICAT, Paris La Defense Cedex (FR); CIMENTS VIGIER SA, Commune de Pery (CH)

(21) Appl. No.: 10/265,198

(22) Filed: Oct. 7, 2002

(30) Foreign Application Priority Data
Aug. 8, 2002 (FR) 0210109

(51) Int. Cl. C04B 7/36

(52) U.S. Cl. 106/739; 106/758; 106/771

(57) ABSTRACT

The invention relates to a process for the manufacture of cement, whereby a metal oxide known for its catalytic action in the reduction of nitrogen oxides NOx, selected from the group consisting of CuO, Co₃O₄, Mn₃O₄, Fe₂O₃, SnO₂, NiO, ZnO, V₂O₅ and TiO₂ is injected into the cement plant kiln flame and/or the precalcination zone flame if there is one.

The preferred metal oxide is iron oxide which, depending on the quantity injected, makes it possible to reduce the rate of NOx in the gases rejected by the cement plant kiln and modulate the concentration of iron oxide in the final clinker.

The invention also relates to a process for reducing NOx content in the gases emitted by the cement plant kiln.

### SCOPE OF THE INVENTION

The present invention concerns an improvement to cement manufacturing processes with a view to reducing NOx emissions in particular.

### BACKGROUND TO THE INVENTION

The emission of nitrogen oxide is known to be one of the major problems encountered in the cement industry, due to the particularly high temperatures required in the cement kiln for the transformation of the raw material—generally referred to as raw meal—into clinker, which, mixed with gypsum, produces cement.

Generally, cement is produced from a clinker prepared in a large-scale rotary kiln, into which a mixture of very finely ground limestone and clay, habitually referred to as “raw meal”, is introduced. This mixture is made up of limestone, silica, alumina and iron oxide, and heated to about 1450° C. by the cement plant kiln flame, whose core burns at around 2000° C. This produces different chemical reactions between the components, also referred to as “clinkerization”.

At that temperature, nitrogen oxides, referred to as NOx (mixtures of NO and NO₂) are generated, from the combination of nitrogen and oxygen at such high flame temperatures.

It is well known that NOx are pollutants, responsible in particular for acid rain, and that strict limitations are placed on factory emissions.

Different solutions have been developed to date to prevent excessive NOx emissions. The industry generally seeks either to treat the emitted gases before they are rejected into the atmosphere, or to modify the clinker production process, in order to limit NOx emissions.

One example of a process which causes a considerable reduction in NOx emissions appears in U.S. Pat. No. 6,113,684, which relates to a particular composition of raw meal used for producing clinker at lower temperatures (900 to 1200° C.).

A publication entitled “Katalytische Reduktion von Stickstoffmonoxid mit Kohlenmonoxid über Zementrohmehl”, appearing in Zement-Kalk-Gips n^{o} 5/1978, 242-244, describes the reaction between NO and CO in the presence of the different components of raw meal. The study was carried out under atmospheric pressure at temperatures of between 700 and 1000° C., similar to those used to pre-heat the raw meal prior to clinkerization. The study concluded that it is possible to reduce NOx content thanks to the use of raw meal or a CaCO₃/Fe₂O₃ mixture in that part of the installation where pre-heating is carried out.

The inventors of the present invention have now observed that it is possible to reduce nitrogen oxide emissions by at least 20%, by injecting metal oxides directly into the kiln flame.

They have also discovered that, when the process includes a precalcination stage before introduction of the pre-heated meal into the kiln, it is also possible to reduce NOx emissions by injecting metal oxide into the precalcination flame, such injection being in that case possibly carried out in complement to an injection of metal oxide into the main kiln flame.

### SUMMARY OF THE INVENTION

According to one essential features, the invention relates a cement manufacturing process which includes a stage during which the raw meal is burned by the main kiln flame, this raw meal having first been pre-heated and in some cases, precalcined by a precalcination flame. The process is characterized by the fact that it includes the injection into the main flame or, if there is one, into the precalcination flame, of a metal oxide known for its catalytic action in the reduction of nitrogen oxides (NOx). This metal oxide is selected from the group consisting of CuO, Co₃O₄, Mn₃O₄, Fe₂O₃, SnO₂, NiO, ZnO, V₂O₅ and TiO₂.

As explained above, the metal oxide can be injected either into the flame of the cement plant kiln or into the precalcination zone flame if there is one. In the latter case, the iron oxide is injected in both flames.

However, it has been proved to be preferable to inject at least part of the injection of oxide into the main flame of the cement kin in which the temperature is markedly higher.

According to the inventors' preferred variant, all the metal oxide is injected into the main kiln flame. However, where there is a precalcination zone, the injection of metal oxide into the main flame may be supplemented by an injection into the precalcination flame.

One of the essential advantages of the process invented indeed, has proved to be the injection of metal oxides at very high temperatures and in the presence of a large quantity of carbon monoxide from the incomplete combustion at the core of the flame, which renders NOx reduction particularly efficient; indeed, the higher the temperature, the more efficient the NOx reduction.

Iron oxide proved to be particularly advantageous due, on the one hand, to its catalytic activity, and on the other, to the added benefit that it modulates the iron oxide content of the final clinker on condition that it is incorporated in volumes in excess of the catalytic quantity.

The first advantage of the process invented, therefore, is that it can be applied in any conventional plant used for the production of clinker for cement.

A further advantage of the process, when the metal oxide used is iron oxide, is that by playing on the quantity of iron oxide injected into the cement plant kiln flame, it is possible to modulate the iron oxide content of the cement produced which can be modified for industrial reasons, for a specific application of the clinker, for which an increased iron oxide content may be desired, without having to modify the composition of the raw meal used to make the clinker.

### BRIEF DESCRIPTION OF THE DRAWINGS

The invention and its advantages will be more readily understood on reading the following detailed description made with reference to FIGS. 1 to 3, in which:

FIG. 1 schematically shows a conventional cement kiln;

FIG. 2 schematically shows a precalcination zone that can be incorporated into the installation shown in FIG. 1;

FIG. 3, given with reference to Example 1, shows a variation curve of NOx content in the gases emitted by the cement plant kiln before and during the process according to the invention;

FIG. 4, given with reference to Example 2, shows the variation in NOx content of gases rejected by the installation using a higher metal oxide concentration;

FIG. 5, given with reference to Example 3, shows variations in the mean NOx concentration as well as in the mean concentration related to an 11% oxygen concentration, in the gases rejected in the course of the trial described in Example 3.

### DESCRIPTION OF THE PREFERRED EMBODIMENT

Limestone and marl are known to be the raw materials used in the manufacture of cement.

Once extracted, these two raw materials are ground, mixed and then burned at around 1450° C. to produce clinker which is ground then mixed with gypsum to produce cement.

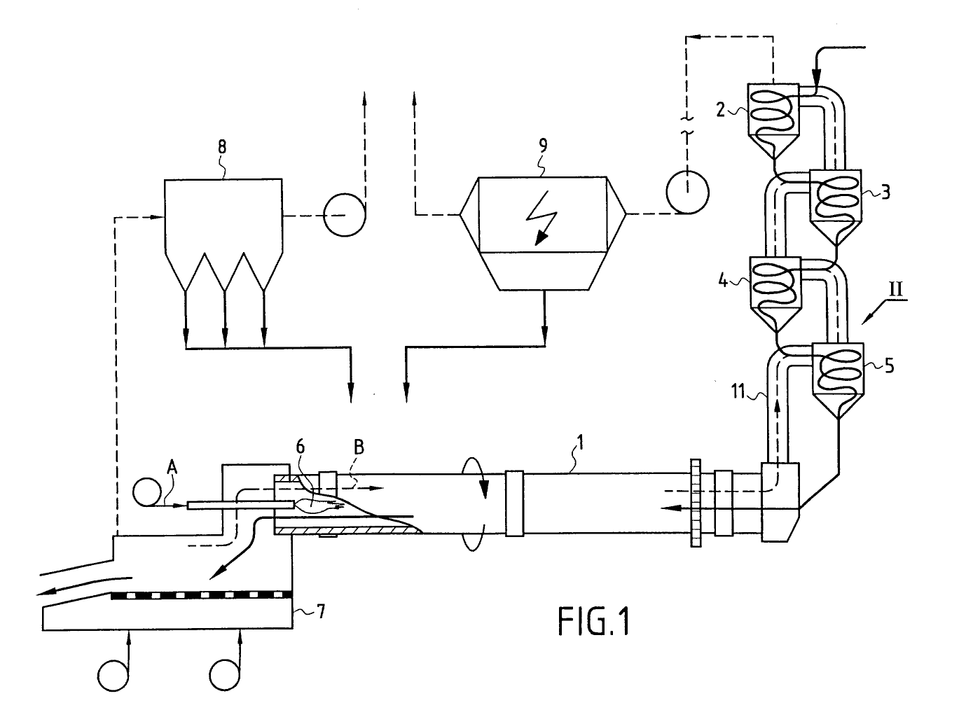

This clinker-producing operation is generally carried out in an installation of the type shown in FIG. 1. FIG. 1 schematically shows the installation where the meal is transformed into clinker in a kiln (1) by burning the materials at a temperature of about 1450° C. This stage is the key operation in the cement production process.

As shown in FIG. 1, this burning process is preceded by the pre-heating of the raw meal in a pre-heater tower equipped with heat exchanger cyclones (2, 3, 4 and 5). The meal, pre-heated to a temperature of around 850 to 900° C., is then introduced into the kiln through the last cyclone (5).

FIG. 1 shows the example of a pre-heater tower equipped with 4 exchangers, marked 2, 3, 4 and 5.

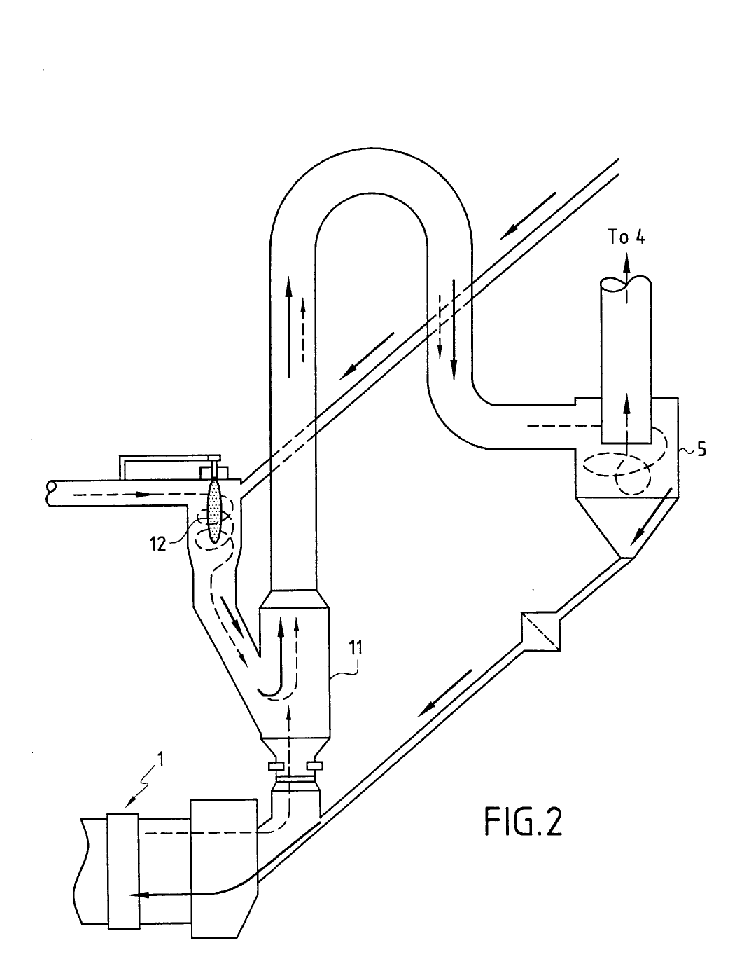

The pre-heating process may include a precalcination zone, such as shown in the diagram in FIG. 2. This precalcination zone is installed between two cyclones (4 and 5) as shown in FIG. 1.

When the cement manufacturing process includes a precalcination stage, some of the heat energy used for manufacturing the clinker is applied at this stage.

More precisely, the pre-heated meal from the cyclone (4) undergoes precalcination under the action of the precalcination flame (12), at a temperature of about 1200° C., produced by a burner into which fuel is injected with tertiary air. This fuel may be similar to or different from that used for the main kiln flame.

The now precalcined meal is then sucked by the cyclone (5), before being introduced into the kiln (1).

The meal, pre-heated and in some cases precalcined as indicated above, is then burned in the rotary kiln (1), where the material slides along the refractory brick-lined walls, before reaching the burning zone at a temperature of around 1450° C., via the flame (6), which burns at around 2000° C. At this stage, the minerals contained in the meal react in a semi-liquid state to form a new mineralogical compound called clinker.

The kiln flame is produced by the main burner, into which fuel is injected along with what is referred to as “primary air”, as represented symbolically by arrow A. The flame is also fed with secondary air, generally coming from the cooler, introduced as indicated by arrow B.

The temperature of the flame is generally around 2000° C. Different types of liquid or solid fuel may be used. In general, coal, petroleum coke, high-viscosity fuels or different substitute fuels such as animal meal, solvents or miscellaneous combustible waste are used.

The incandescent mass then leaves the kiln and passes through the cooler (7), where the temperature of the clinker falls substantially, to about 80° C. The clinker is then transported to a silo or storage area before being ground and mixed with gypsum to form cement.

The direction of gases and material is indicated in FIGS. 1 and 2 respectively, by discontinuous arrows for gas, and solid-line arrows for material.

The combustion gases from the kiln leaving the pre-heating zone, and the excess cooling air are purified stage by filters (8 and 9), before being rejected into the atmosphere.

It is common practice to measure the NOx content of gases from the cement plant kiln immediately at the outlet of the kiln in what is called the feed end housing (11), using a probe.

As explained above, the process detailed in the invention can be applied to any conventional cement factory of the type shown in FIG. 1, possibly supplemented by the enhancement outlined in FIG. 2 including, or not, a precalcination stage such as shown in FIG. 2, and presents the advantage of not requiring any particular re-arrangement of the installation, given that the only modification to the conventional process is the introduction of metal oxide into the kiln flame, or at least into one of the two flames (the main flame or the precalcination flame) in those cases where there is a precalcination zone.

It may be injected directly into the flame, in particular in the form of a finely-ground powder which is injected into the burner.

A mixture with liquid or solid fuel may also be injected into the burner to feed the flame.

With a solid fuel such as petroleum coke, it is advantageous to introduce the metal oxide once it has been ground together with the fuel.

As explained above, the metal oxide can be selected from the group known for their catalytic action on the reduction of NOx. However, as the oxide Fe₂O₃ is a component of clinker, it is particularly advantageous to use it for the process described in the invention.

This choice avoids any risk of pollution of the cement by the metal oxide used.

It has the added benefit of being able to modify the iron oxide composition of the clinker as desired.

The quantities of metal oxide may vary substantially. A skilled professional will easily be able to determine the minimum quantity to inject to obtain the desired catalytic effect through simple routine trials.

The maximum quantities that can be injected will likewise be determined through routine trials by optimizing them for the reduction of NOx content in the gases expelled by the kiln, without the risk of modifying the metal oxide content of the final clinker more than desired.

The quantities of metal oxide used will, of course, also depend on the quantities and flow rates of raw meal processed.

Indeed, it is well known that the quantities of NOx generated are very closely linked to the heat balance of the clinker-producing equipment.

Heat balance, which is conventionally used in the cement industry to characterize the operation of the equipment, indicates the thermal energy used to manufacture the clinker.

This energy is generally of the order of 3100 to 4000 MJ per ton of clinker. In fact, this heat balance is fairly representative of the quantity of NOx generated.

In general, where the oxide used according to the present invention was iron oxide, it was proved during the trials carried out by the inventors to be advantageous to introduce between 0.1 g and 17 g of iron oxide per MJ of heat balance.

The introduction of this quantity of iron oxide into the flame of the kiln considerably reduced the NOx content of the gases in all cases.

If NOx content reductions of at least 20% are sought without substantially modifying the concentration of iron oxide in the final clinker, ie: by introducing a less than 3% modification in the iron oxide content, it is preferable to introduce between 0.1 and 8 g of iron oxide per MJ of heat balance of the kiln.

When, for technical reasons, iron oxide content in the clinker produced needs to be modified to varying degrees, the amount of iron oxide can be adjusted. For example, to increase its content in clinker from 3 to 5% by weight, between 8 and 17 g of iron oxide per MJ of heat balance is introduced into the flame, or at least, into one of the flames when the installation includes a precalcination zone.

As explained above, the metal oxide which least pollutes the clinker produced will be the one chosen.

This is why iron oxide Fe₂O₃ is the metal oxide preferred for this invention.

Different sources of iron oxide may be chosen.

A commercial iron oxide may be used, such as an iron oxide powder containing at least 75% iron oxide (eg: pyrite ash).

Different mixtures containing minimum quantities of iron oxide may also be chosen as the iron oxide source. Particular mention is made of those which include other elements beside iron oxide, other elements which themselves are contained in the clinker produced, in particular mixtures containing at least 2% by weight of iron oxide, the remainder of said mixtures being primarily oxides chosen from Al₂O₃, SiO₂ and CaO.

Examples of these mixtures include the raw meals such as those conventionally used in the manufacture of clinker, such as meal containing between 2 and 8% by weight of iron oxide Fe₂O₃.

The metal oxide powders used in the process described in the invention have fineness which may vary within fairly wide limits, while remaining compatible with the conditions of injection, either directly into the flame via the burner, or mixed with fuel.

Mixtures will advantageously be used when their fineness corresponds to between 10 and 20% residue over 90 μm sieve.

According to a second characteristic, the invention relates to a process for reduction of the emissions of NOx generated by the kiln of a cement factory, comprising, upstream of the plant, a raw meal pre-heating zone and possibly a meal precalcination zone, after pre-heating and prior to entry into the kiln, characterized by the fact that it involves injecting into the cement kiln flame and/or into the precalcination zone flame under the conditions described above, an iron oxide selected from the group consisting of CuO, Co₃O₄, Mn₃O₄, Fe₂O₃, SnO₂, NiO, ZnO, V₂O₅ and TiO₂, preferably iron oxide Fe₂O₃, in efficient quantities to reduce NOx content in exhaust gases by at least 20%.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated.

### EXAMPLES

### Example 1

### Reduction of NOx Emissions by the Introduction of Pyrite Ash into the Cement Plant Kiln Flame

The NOx content of the gases emitted by a kiln of an installation of the type shown in FIG. 1, processing 100 tones of raw meal per hour, was continuously recorded, using a SICK G30 probe.

At time t₁=35 hours, injection of Fe₂O₃ directly into the kiln burner began, at a rate of 0.8 tons per hour, the other operational conditions remaining identical. Injection continued in this manner for 9 hours.

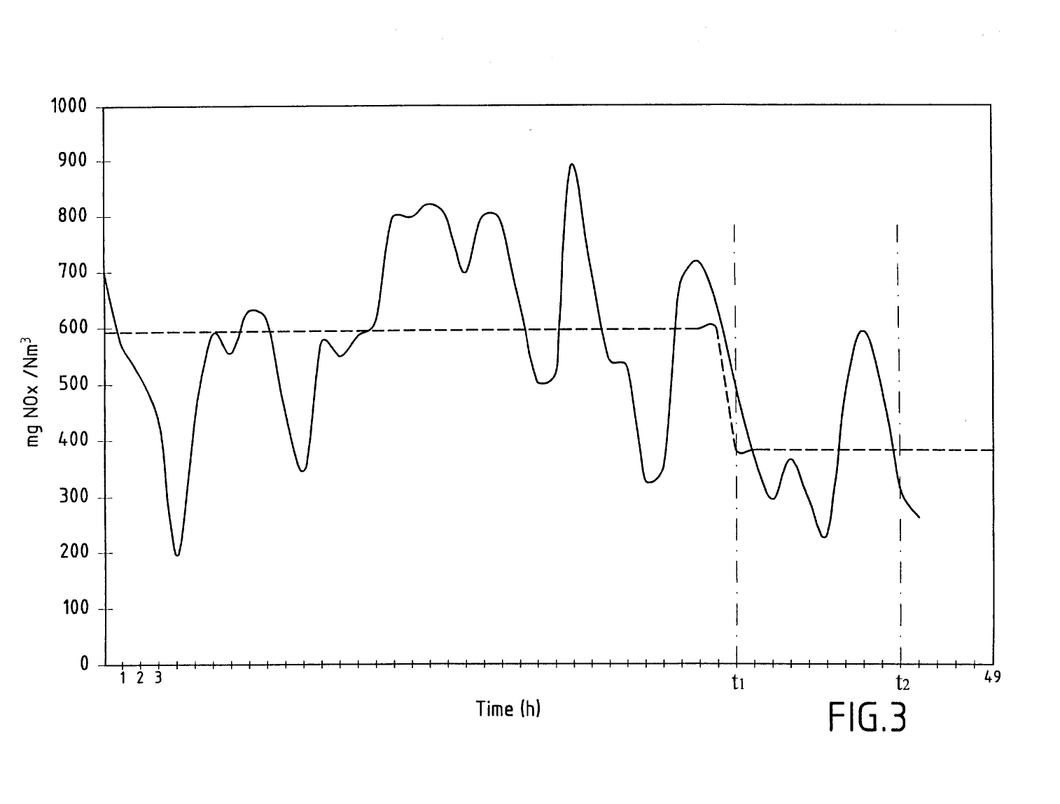

FIG. 3 shows that the mean rate of NOx in the gases fell from a mean value of 596 mg/Nm³ in the absence of Fe₂O₃, to a value of 381 mg/Nm³ in the presence of Fe₂O₃, which corresponds to a NOx rate reduction of 36%.

### Example 2

### Enrichment of Clinker with Iron Oxide and Simultaneously Reduction of Nitrogen Oxide Content in Exhaust Gases

The installation used for this trial is the one shown in FIG. 1. The raw meal was introduced at a rate of 65 tons per hour, throughout the trial.

The only modification made in the course of the trial was the introduction, starting at time t′₁=2 days and 7 hours, of 2 tons (i.e. 2.10³ kg) of pyrite ash per hour injected directly into the kiln main burner. This injection was continued for 49 hours up to time t′₂.

3 hours after the start of the iron oxide injection, the clinker produced showed an iron oxide content of 6.2% by weight against 2.7% before the beginning of the injection of iron oxide, and from the time of injection of the Fe₂O₃ into the flame, there was a marked reduction in NOx content in the gases emitted by the kiln.

The content increased again as soon as injection of pyrite ash into the flame ceased (after 2 days using pyrite ash).

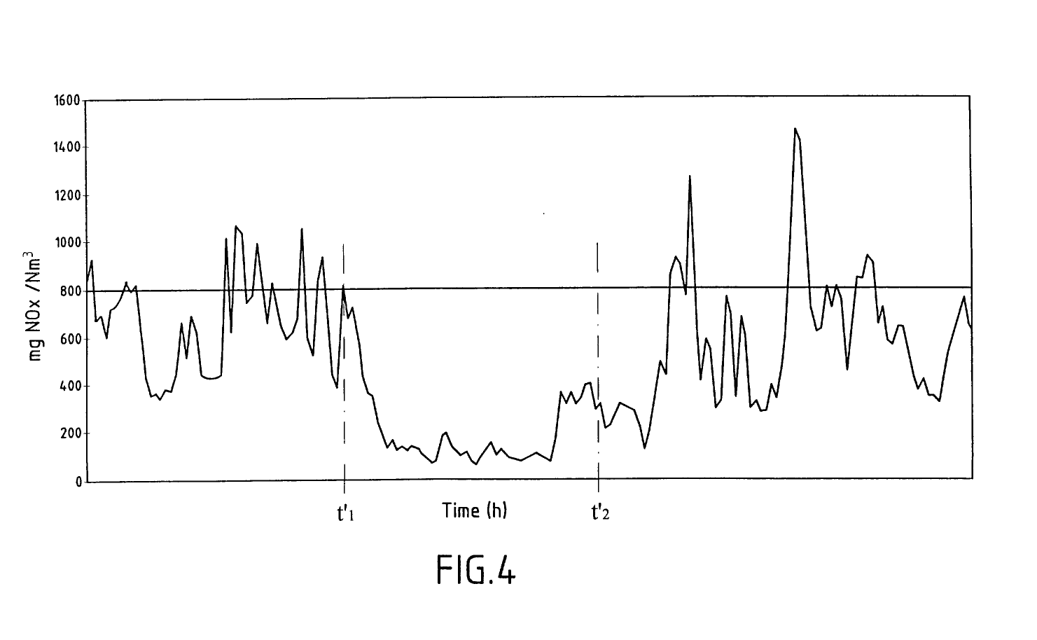

More precisely, the average over the whole trial, as represented in FIG. 4, proved to be 497 mg of NOx/Nm³, against 205 mg/Nm³ using pyrite ash.

The following table presents an analysis of the clinker produced during that part of the trial where iron oxide was being injected into the flame.

The table shows that the invention makes it possible to prepare clinker with increased iron oxide content, making it possible in particular to envisage special applications, particularly when a cement's specific resistance to water containing sulphates is sought.

CLINKER ENRICHED WITH PYRITE ASH

| | Chemical composition | | | | | | |
|---|---|---|---|---|---|---|---|
| sample | SiO₂ | Al₂O₃ | Fe₂O₃ | CaO | MgO | SO₃ | K₂O |
| t′₁ + 2 hrs | 21.1 | 4.6 | 6.2 | 63.4 | 2.2 | 1.1 | 0.8 |
| t′₁ + 8 hrs | 20.3 | 4.6 | 8.9 | 61.2 | 2.3 | 1.3 | 1.1 |
| t′₁ + 14 hrs | 20.5 | 4.8 | 7.9 | 62.0 | 2.3 | 1.3 | 0.9 |
| t′₁ + 20 hrs | 20.5 | 4.9 | 7.3 | 62.0 | 2.2 | 1.5 | 1.1 |
| t′₁ + 26 hrs | 20.3 | 4.7 | 9.0 | 62.0 | 2.2 | 0.8 | 0.8 |
| t′₁ + 32 hrs | 20.1 | 4.7 | 8.0 | 61.4 | 2.2 | 1.8 | 1.0 |
| t′₁ + 38 hrs | 20.5 | 4.8 | 7.9 | 62.0 | 2.3 | 1.3 | 0.9 |
| t′₁ + 44 hrs | 20.5 | 4.9 | 7.3 | 62.0 | 2.2 | 1.5 | 1.1 |
| t′₁ + 50 hrs | 20.2 | 5.0 | 7.7 | 61.7 | 2.2 | 1.6 | 1.1 |

### Example 3

### Other Examples of Use of the Invention by Injecting Fe₂O₃ Mixed with a Solid Fuel

Three different trials were carried out, each with duration of 12 to 24 hours.

Iron oxide was used, which had been ground in a mill with petroleum coke to reduce particle size.

The final fineness of the petroleum coke/iron oxide mixture was 5% residue over a 200 μm sieve.

NOx content was measured at the feed end housing, ie: above the end of the kiln, using a Siemens probe.

For these trials, the cement plant kiln was fed with raw meal at a rate of 180 to 220 tons per hour.

During the trials, the rate of Fe₂O₃ varied from 300 kg/hr to 600 kg/hr in the burner.

At these rates, the variations in chemical composition of the clinker, with the addition of iron oxide, are negligible.

With 300 kg/hr iron oxide input, a NOx reduction of the order of 20 to 30% was recorded.

With 600 kg/hr of Fe₂O₃, a NOx reduction of over 35% was recorded.

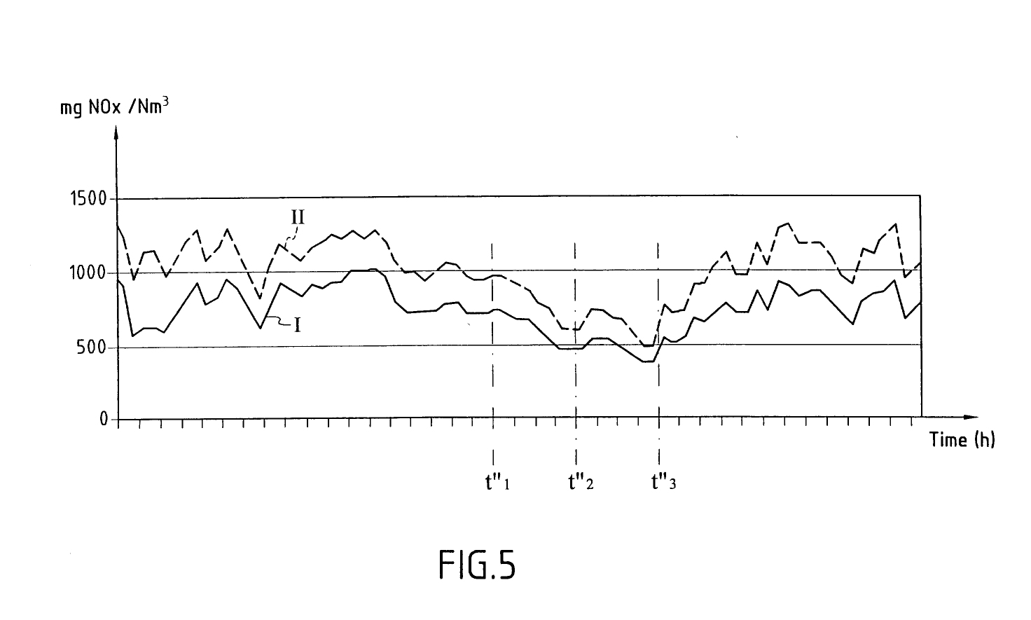

Curves I and II shown in FIG. 5 give, respectively, the mean concentrations of NOx (curve I) and the mean concentrations of NOx related to 11% of oxygen in the gases measured at the feed end housing in the course of one of the trials described above, during which 300 kg/hr of iron oxide was injected for 4 hours (between times t″₁ and t″₂ in FIG. 4), then 600 kg/hr for the following 4 hours (between the times t″₂ and t″₃ in FIG. 5).

The curves indicate that the reduction in the mean concentration of NOx in the gases collected in the feed end housing is of the order of 18% for a rate of 300 kg/hr of iron oxide and around 36% at 600 kg/hr.

The entire disclosure of all applications, patents and publications, cited herein and of corresponding French Application No. 0210109, filed Aug. 8, 2002 is incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A process for manufacturing cement, including a burning stage, under the action of what is referred to as a cement plant kiln flame, having first been pre-heated and optionally precalcined using a precalcination flame, wherein it comprises the injection into the cement plant kiln flame and/or, when the process includes a precalcination stage, into the precalcination flame, of a metal oxide known for its catalytic action in the reduction of NOx nitrogen oxides, selected from the group consisting of CuO, Co₃O₄, Mn₃O₄, Fe₂O₃, SnO₂, NiO, ZnO, V₂O₅ and TiO₂.

2. The process according to claim 1, wherein it comprises the injection of said metal oxide into the cement plant kiln flame.

3. The process according to claim 1, wherein it comprises precalcining the raw meal which has previously been pre-heated before the burning stage, and wherein at least part of said metal oxide is introduced into the said precalcination flame.

4. The process according to claim 1, wherein said metal oxide is injected directly into the kiln flame, and/or into at least one of the flames when said process includes a precalcination stage.

5. The process according to claim 1, wherein said metal oxide is injected after being mixed with at least one fuel used to feed the kiln flame and/or into at least one of the flames when said process includes a precalcination stage.

6. The process according to claim 5, wherein said fuel is a solid fuel, and said metal oxide is mixed and ground with that fuel.

7. The process according to claim 1, wherein said metal oxide is iron oxide.

8. The process according to claim 7, wherein the iron oxide is introduced at a rate of 0.1 to 17 g per MJ of heat balance of the cement kiln.

9. The process according to claim 7, wherein from 0.1 to 8 g of iron oxide per MJ of heat balance of the kiln is introduced, so as to obtain a NOx content reduction of at least 20% and a concentration of iron oxide in the modified clinker of less than 3%

10. The process according to claim 7, wherein from 8 to 17 g of iron oxide per MJ of kiln heat balance is introduced so as to obtain both a reduction of at least 20% of the nitrogen oxide content of the gases from the kiln and an effect of correction of the iron oxide content of the clinker produced, enriching it in iron oxide by about 3 to 5% by weight.

11. The process according to claim 7, wherein said iron oxide is introduced in the form of a mixture containing at least 2% by weight of iron oxide, the rest of said mixture being made up of oxides selected from the group consisting of Al₂O₃, SiO₂ and CaO.

12. The process according to claim 11, wherein said mixture is raw meal for clinker manufacture, said raw meal containing between 2 and 8% by weight of iron oxide Fe₂O₃.

13. A process for reducing the NOx emissions generated by the kiln of the cement plant, comprising upstream of said kiln, a raw meal pre-heating zone, possibly followed by a raw meal precalcination zone prior to input into said kiln, wherein an oxide selected from the group consisting of CuO, Co₃O₄, Mn₃O₄, Fe₂O₃, SnO₂, NiO, ZnO, V₂O₅ and TiO₂ is injected into the cement plant kiln flame and/or the precalcination zone flame, under the conditions described in claim 1, in an efficient quantity to obtain a reduction of at least 20% of the NOx content of the gases emitted by the cement plant kiln.

14. The process of claim 13, wherein said oxide is Fe₂O₃.
